(19) United States
(12) Patent Application Publication
(10) Pub. No.: US 2009/0180872 A1
(43) Pub. Date: Jul. 16, 2009

(54) GAS TURBINE CASING FOR ENCLOSING A GAS TURBINE COMPONENT

(75) Inventor: Jan Lundgren, Grundsund (SE)

Correspondence Address: WRB-IP LLP, 1217 KING STREET, ALEXANDRIA, VA, 22314, US

(73) Assignee: VOLVO AERO CORPORATION, Trollhättan (SE)

(21) Appl. No.: 11/576,212

(22) PCT Filed: Sep. 28, 2005
(86) PCT No.: PCT/SE05/01439

§ 371 Date: Mar. 28, 2007

(30) Foreign Application Priority Data
Oct. 7, 2004 (SE) 0402440-2

(51) Int. Cl. F01D 25/24; B23P 15/04

(52) U.S. Cl. 415/215.1; 29/889.2

(57) ABSTRACT

A gas turbine casing for enclosing a gas turbine component, such as a fan, a compressor, a combustion chamber or a turbine is provided. The casing includes a double wall structure having a first inner tube and a second outer tube, the first inner tube and the second outer tube extending around a geometric longitudinal axis, which is intended to basically coincide with a longitudinal geometric central axis of a gas turbine. The first inner tube and the second outer tube overlap one another when these are viewed in a radial direction, a gap being formed between the outer boundary surface of the first inner tube and the inner boundary surface of the second outer tube. The double wall structure furthermore has a plurality of stays which take the form of plates, which are spaced at an interval from one another and extend radially between the first inner tube and the second outer tube, and which stays connect the first inner tube and the second outer tube to one another.

### BACKGROUND AND SUMMARY

The present invention relates to a gas turbine casing for enclosing a gas turbine component, such as a fan, a compressor, a combustion chamber or a turbine, and to a method of forming a gas turbine casing for enclosing a gas turbine component such as a fan, a compressor, a combustion chamber or a turbine.

The invention relates in particular to such a casing for use in aviation applications comprising part of an aircraft engine, such as a jet engine.

A gas turbine constituting an engine for aviation applications usually comprises the main components: fan, compressor, combustion chamber and turbine. An afterburner chamber may be arranged downstream of the turbine component. The engine furthermore comprises one or more casings, which enclose the aforementioned components. The casing must have the requisite strength whilst at the same time it is desirable for the entire construction, which therefore includes the casing, to have the lowest possible weight in order to give the engine the best possible performance, that is to say the engine achieves a large thrust in relation to its weight.

Although a gas turbine for aviation applications, hereinafter also referred to as an engine, is primarily being described, it must be emphasized that the invention could also be applied to a stationary gas turbine for power generation. The casings for gas turbine engines are in the state of the art usually designed as hollow circular cylinders arranged concentrically in relation to the central axis of the engine. Such a casing forms an enclosing shell around the rotating and stationary engine components. Such a cylinder may have an inside diameter in the order of 400 to 1800 mm and a material thickness in the order of 3 to 10 mm. The casing may be formed from one or preferably more such cylinders having a varying diameter, the cylinders being joined to one another in order to form a continuous shell in the form of a tube.

One of the primary factors largely determining the requisite strength of the casing is the bending stress that occurs in the engine. This problem is particularly manifest in certain parts of the casing where the engine may have a waist which means that the casing has a relatively small diameter. This may be the case, for example, with the parts of the casing which enclose the compressor, which may have an intermediate compressor stage and a high pressure compressor stage, for example. Flexing of the engine may mean that rotors scrape, that excessive amounts of play occur or that rotating shafts are bent etc. Another problem which affects the strength and which to a large extent influences the choice of material in the casing are the relatively high temperatures to which the casing is exposed whilst the engine is in operation. In gas turbines the casing reaches temperatures ranging approximately from 200 to 800° C.

A known method of producing a casing, which is sometimes used as an outer shell of a gas turbine engine affording a somewhat greater flexural rigidity for the same weight, is to design the casing with external elevations or ridges which form a square grid pattern on the outside of the casing. The ridges may be produced either by cutting away material from the basic fabrication of the casing or by applying material to the basic fabrication. In both cases, however, the manufacturing process is relatively complicated and this means that such a casing becomes considerably more expensive than a corresponding casing having a plane external surface.

It is desirable to provide a casing of the type defined in the introductory part, which represents an alternative to conventional plane casings and casings provided with external ridges, and which has the characteristic that for a given flexural and/or torsional rigidity of the casing, the casing has a lower weight than a corresponding conventional casing having a basically plane external surface, the casing at the same time affording the facility for effective cooling.

A construction having a relatively high flexural rigidity is obtained in that the casing comprises a double wall structure having a first inner tube and a second outer tube, the first inner tube and the second outer tube extending around a geometric longitudinal axis, which is intended to basically coincide with a longitudinal geometric central axis of a gas turbine, and the first inner tube and the second outer tube overlapping one another when these are viewed in a radial direction, a gap being formed between the outer boundary surface of the first inner tube and the inner boundary surface of the second outer tube, and that the double wall structure furthermore has a plurality of stays which take the form as plates, which are spaced at an interval from one another and extend radially between the first inner tube and the second outer tube, and which connect the first inner tube and the second outer tube to one another.

The construction can be utilized in order to obtain a greater flexural rigidity and/or a lower weight for a given size of casing. Such a load carrying structure can absorb the bending stresses arising in a gas turbine, such as a gas turbine engine. The use of such a casing in a position in a gas turbine where the gas turbine has a waist is particularly advantageous. A gas turbine engine is often suspended at the front and rear part of the engine. The engine casing enclosing the moving components connects these two suspension points. While the bending torque is at its largest between the suspension points, the engine often has the smallest cross section in a position substantially halfway between the suspension points. The bending stresses will therefore be critical in this region and the casing must have sufficient flexural rigidity in order to avoid the aforementioned problems of scrape etc.

The casing according to the invention furthermore has the advantage that the gap that is formed between the first inner tube and the second outer tube can be used for conveying a cooling medium, such as air, and/or for conveying a fuel, for the purpose of cooling the casing and/or other parts of a gas turbine. This in turn affords scope for the use of those materials which without cooling could not be used in a corresponding gas turbine.

The invention further relates to a method of forming a casing for enclosing a gas turbine component such as a fan, a compressor, a combustion chamber or a turbine.

Other advantageous features and functions of various embodiments of the invention are set forth in the following description.

### BRIEF DESCRIPTION OF THE DRAWINGS

There follows a detailed description of embodiments of the invention, cited by way of example and with reference to the drawings attached, in which:

FIG. 1a is a perspective view of a gas turbine casing in the state of the art, having a plane external surface,

FIG. 1b is a perspective view of a gas turbine casing in the state of the art, having a surface provided with external ridges forming a square grid pattern,

FIG. 2 is a schematic, sectional view of a part of a gas turbine engine,

FIG. 3 is a partially sectional perspective view of a casing according to the invention for enclosing a gas turbine component,

FIG. 3b is a plan view corresponding to FIG. 3 showing a variant of the casing according to the invention,

FIG. 4a is an enlarged partial view illustrating a cross-section of the arrangement in FIG. 3,

FIG. 4b is a variant of the arrangement according to FIG. 4a,

FIG. 4c is a variant of the arrangement according to FIG. 4a,

FIG. 5 is a partially sectional perspective view of a variant of a casing according to the invention for enclosing a gas turbine component, and FIG. 6 is a sectional, partial view of the arrangement in FIG. 5.

### DETAILED DESCRIPTION

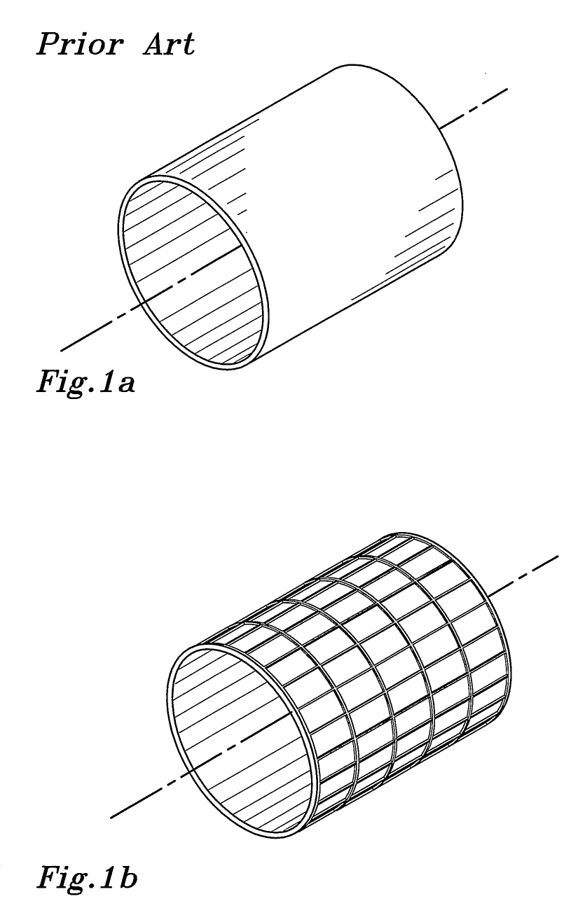

On gas turbines there are often a number of casings or shells. In some cases two or more shells are arranged concentrically with one another around the rotor shaft of the gas turbine. A common feature of these hitherto known constructions, however, is that each separate casing comprises a homogeneous tube or ring. FIGS. 1a and 1b show examples of such casings according to the state of the art. FIG. 1a shows a tube with an external surface which is plane and FIG. 1b shows a corresponding tube provided with elevations or ridges, which form a square grid pattern.

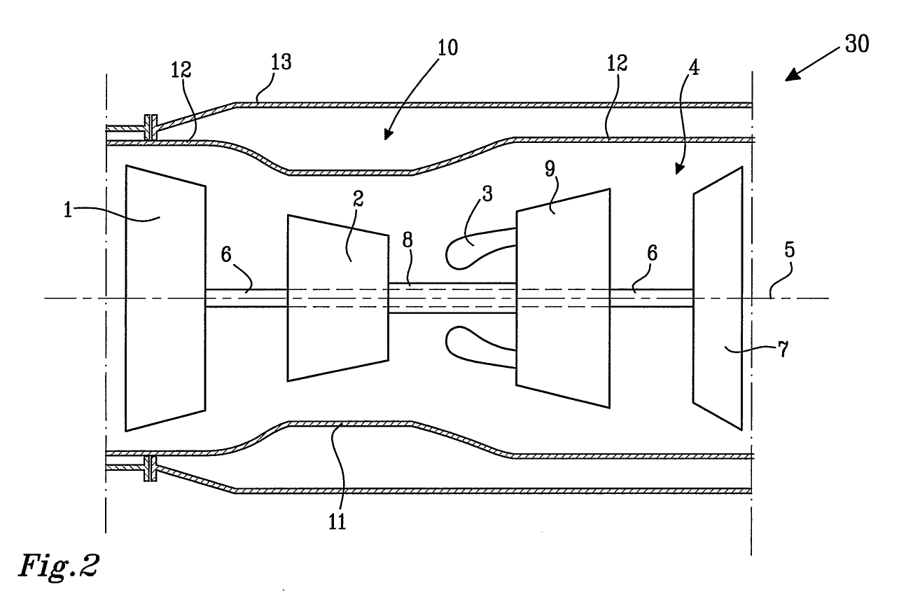

FIG. 2 is a schematic illustration of a part of a gas turbine engine. The engine comprises a fan 1, a compressor 2, one or more combustion chambers 3 and a turbine 4 arranged along a longitudinal central axis 5, which coincides with the rotor shaft of the engine. The gas flow direction in the engine shown is thus from left to right in FIG. 2. The fan 1, which could also be a low-pressure compressor component, is driven via a shaft 6 of a low-pressure turbine component 7. The engine has a waist 10 at the compressor 2, which in the example illustrated is a high-pressure compressor and which, via a shaft 8, is driven by a high-pressure turbine component 9. This means that an inner casing 11, which encloses the compressor 2 and which is arranged nearest to the rotor 5, has a diameter which is less than corresponding casing sections 12, which are situated downstream and upstream of the compressor 2. A further casing 13 can be arranged outside the inner casing 11, so that the engine therefore has two shells 11, 13 at different distances from the rotor. According to the state of the art such shells 11, 13 are in principle constructed from such components as those shown in FIGS. 1a and 1b.

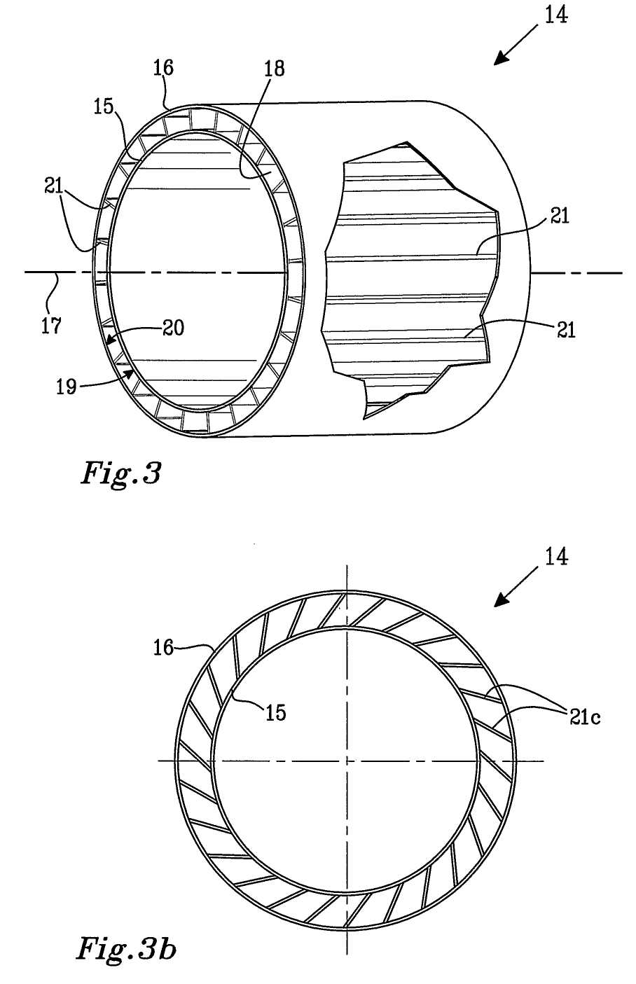

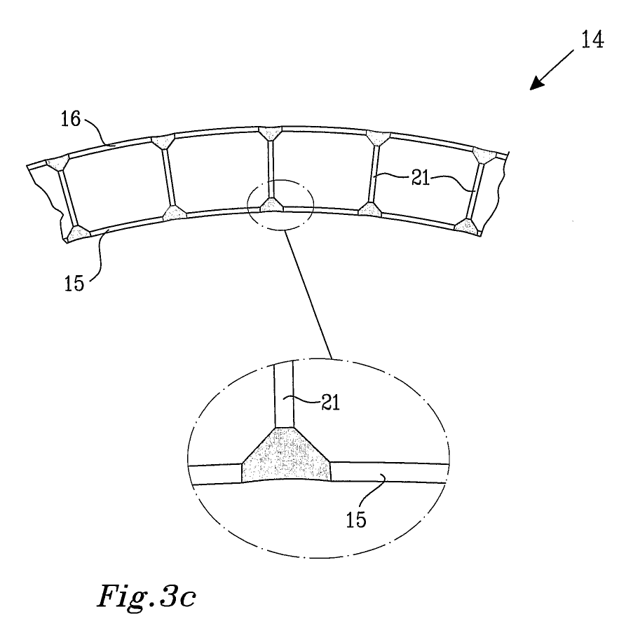

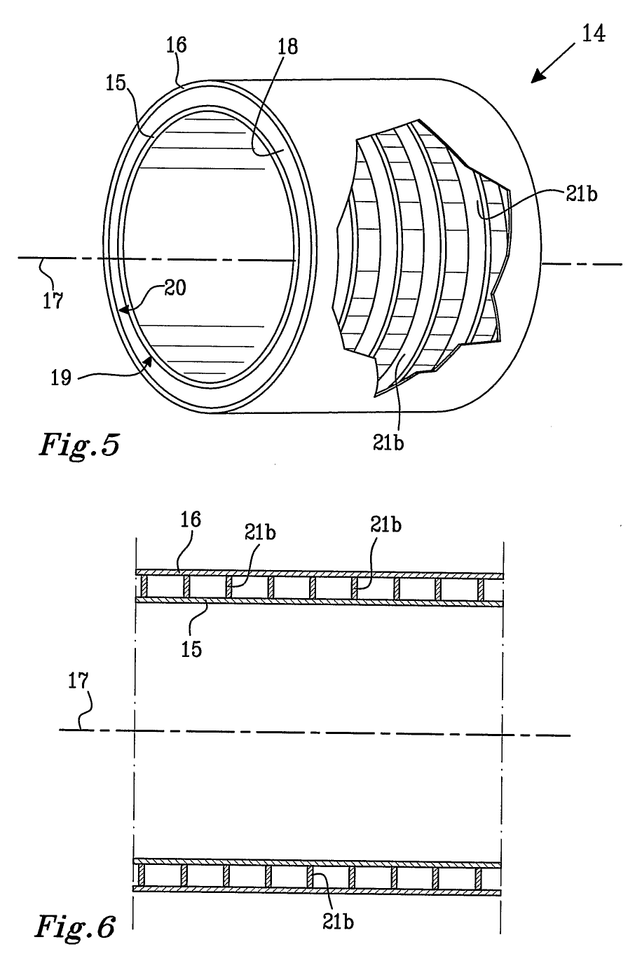

The invention is intended for application to an aforementioned shell, so that an individual casing consists of a double wall structure. FIGS. 3 and 5 illustrate two variants of a casing according to the invention. The double wall structure 14 according to the invention, which can be applied either to the inner casing 11 or the outer casing 13, or to any other corresponding casing, has a first inner tube 15 and a second outer tube 16 for forming a casing. The two tubes 15, 16 extend around a geometric longitudinal axis 17, which is intended to coincide with the longitudinal central axis 5 of the gas turbine. The first inner tube 15 and the second outer tube 16 overlap one another when viewed in a radial direction, a gap 18 being formed between the outer boundary surface 19 of the first inner tube 15 and the inner boundary surface 20 of the second outer tube 16. In other words, the first inner tube and the second outer tube overlap one another when these are viewed in a radial direction from a position outside the casing looking towards the center of the casing, or in a radial direction from a position inside the casing looking outwards from the center of the casing, and perpendicular to the geometric longitudinal axis 17, which extends in the axial direction. The double wall structure 14 further comprises a plurality of stays 21 which are spaced at an interval from one another and extend radially between the first inner tube 15 and the second outer tube 16, the stays 21 connecting the first inner tube 15 and the second outer tube 16 to one another. This means that the inner tube 15, the outer tube 16 and the stays 21 (after joining the required basic components by welding, for example) form a continuous piece, which cannot be dismantled into the separate basic components. The casing according to the invention must therefore not be confused with any constructions in which separate casings are arranged outside one another and are coupled together by means of a flanged union connection or fasteners in the form of bolts or the like.

The tubes 15, 16, if of circular cross-section, may have a diameter in the order of 200 to 1500 mm, for example. The size of the gap 18 formed between the first inner tube 15 and the second outer tube 16 should be selected having regard to the size of the double wall structure 14, but the dimensions of the tubes are usually matched to one another so that in a radial direction there is a distance between the tubes which is in the order of 1 to 200 mm, and preferably in the range 2 to 50 mm.

Titanium-based material or a mixture of titanium or aluminum and other material could be used for manufacturing the casing according to the invention, these materials preferably being used in casings intended for relatively cool structures of the gas turbine. Nickel-based alloys and stainless steel are preferably used for manufacturing casings intended for relatively hot structures.

The first inner tube 15 preferably has a circular cross-section and the second outer tube 16 likewise has a circular cross-section. The first tube 15 and the second tube 16 are furthermore suitably arranged concentrically with one another. The tubes 15, 16 or the hollow cylinders may naturally be of any length, depending on the application in question. A very short tube will virtually come to form a ring. The length is often in the order of 200 to 1000 mm. The inner tube 15 and the outer tube 16 preferably extend basically parallel in a longitudinal direction.

Although there are advantages to the use of an inner tube and an outer tube having basically the same cross-section shapes but different dimensions, the tubes preferably being placed concentrically with one another, it is quite possible, without departing from the scope of the invention, to form the two tubes with different cross-sectional shapes. The cross-section of the second outer tube, in particular, could well be varied in a number of ways. For example, in one and the same cross-section of the double wall structure the inner tube might have a circular cross-section and the outer tube might have a rectangular cross-section. Embodiments are furthermore feasible in which the inner tube and outer tube have a different center, and in such cases the center of the inner tube suitably coincides with the geometric longitudinal axis intended to coincide with the longitudinal central axis of the gas turbine.

A common feature of the casings according to the invention is that they have a plurality, often more than 5 and preferably more than 10, stays 21, which extend radially between the first inner tube 15 and the second outer tune 16. In many cases it is advisable to use 50 to 200 stays in order to form the casing. There are, however, two main principles for the placing of the stays 21, it being possible to combine the principles or to use them separately.

According to a first main principle illustrated in FIG. 3, the stays 21 are arranged at intervals from one another, preferably at basically equidistant intervals, in a circumferential direction around the double wall structure 14. This means that in addition to a main extent in a radial direction between the tubes 15, 16, the stays 21, which suitably take the form of plates, also have a main extent in the longitudinal direction of the tubes 15, 16. As shown in FIG. 3, these stays 21 are preferably arranged basically parallel to the longitudinal extent of the tubes 15, 16, that is to say parallel to the geometric longitudinal axis 17 (and therefore in many cases basically parallel to the rotor shaft of a gas turbine), but they could also extend obliquely in relation to the longitudinal axes of the tubes. The stays 21 suitably extend over basically the entire length of the double wall structure 12, in order to provide stability along the entire casing. It must be emphasized, however, that in addition to those stays 21 extending in a direction, which if extended will intersect the geometric longitudinal axis 17, or in other words the center of the casing, see FIG. 3, the definition of radially extending stays is also intended to include inclined stays 21. Inclined stays 21c are shown in FIG. 3b. Such an inclined stay 21c is aligned so that an extension of the stay in the direction in which it extends between the first inner tube 15 and the second outer tube 16 does not intersect the center of the casing.

According to the second main principle, which is shown in FIGS. 5 and 6, the stays 21b are arranged at an interval from one another over the longitudinal extent of the double wall structure 14. FIG. 5 is a partially sectional perspective view of such a casing according to the invention and FIG. 6 is a view which shows the casing cut along the longitudinal axis thereof. In this variant of the invention, in addition to a main extent in a radial direction between the tubes 15, 16, the stays 21b, which are suitably formed as plates, also have a main extent in the tangential direction of the tubes or in other words in the circumferential direction. In this case the stays 21b therefore extend over the circumference of the double wall structure 14, and the stays preferably take the form of rings, which extend basically over the entire extent of the double wall structure 14 in a circumferential direction. The stays 21b, which are preferably placed equidistant from one another, often number more than 5 and preferably more than 10, but the number of stays 21b naturally depends on the length of the double wall structure 14. With a very short casing, a lesser number of stays could in this case be sufficient to connect the two tubes together in the desired manner.

In the two main principles described, the height of the stays 21, 21b is adjusted to the gap 18 that is formed between the first inner tube 15 and the second outer tube 16, so that the first inner tube 15 and the second outer tube 16 can be connected by means of the stays 21, 21b. It must be emphasized, however, that the double wall structure 14 may be formed by components which need not necessarily be two tubes and a number of separate stays, it being possible to also use other sets of basic material. The stays in both cases furthermore have a third dimension, that is to say a thickness, which may be varied depending on the desired characteristics of the casing. The thickness of the stays preferably ranges from a few tenths of a millimeter up to tens of millimeters, often in the range from 0.5 to 5 mm.

The double wall structure comprises a first set of stays 21 arranged according to the first principle and a second set of stays 21b arranged according to the second principle. In such a combination the stays will cross one another at a number of positions in the casing. (Should both principles be applied to one and the same stay, this stay will come to extend helically along the casing.)

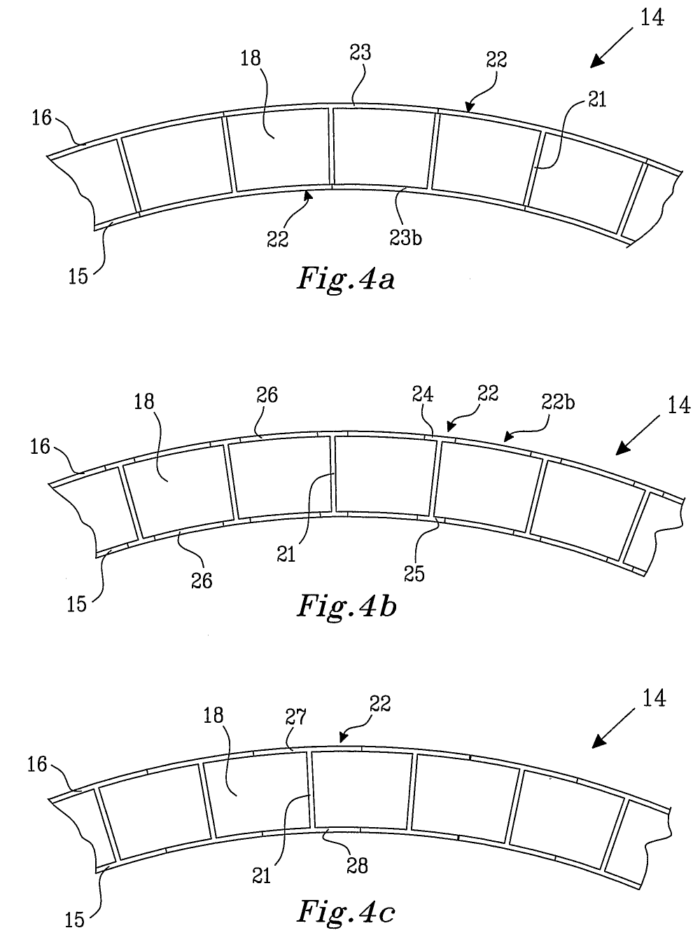

An efficient method of manufacturing the casing according to the invention is to form the double wall structure 14 from a number of modules 22 joined together, see FIG. 4a, for example, arranged side by side in the circumferential direction of the casing. This can be done by arranging modules of the same type directly adjoining one another in order to form the double wall structure. It is also possible, as shown in FIG. 4b, to use different types of modules 22, 22b.

According to one embodiment of the invention, each module 22 has at least one said stay 21, and a part forming a section of the first inner tube 15 and/or a part forming a section of the second outer tube 16, the parts being denoted by 23 and 23b respectively in FIG. 4. For example, modules 22 in the form of I-beams, H-beams and/or T-beams may be used. The modules 22 are preferably manufactured by extrusion. The modules 22 are furthermore suitably joined together by welding and/or soldering.

The method according to the invention for forming such a casing for enclosing a gas turbine component such as a fan 1, a compressor 2, a combustion chamber 3 or a turbine 4 is characterized in that a number of modules 22 are joined together, preferably by welding, side by side in the circumferential direction of the casing so that a double wall structure 14 is formed. In this way the casing according to the invention can be manufactured efficiently through the use, for example, of prefabricated beams. These beams can be manufactured by extrusion in order to obtain the required profile of the beam.

FIGS. 4a, 4b and 4c show some examples of how the casing according to the invention can be formed by joining different modules 22 together. In FIG. 4a the double wall structure 14 is formed by T-beams, which have a flange 23 or 23b extending in a tangential direction, which constitute a section of the inner tube 15 or a section of the outer tube 16, and a flange which runs transversely to the tangentially extending flange and which forms a stay 21 between the tubes 15, 16. The T-beams are arranged side by side and alternately so that in one beam the transverse flange 21 extends from a flange 23b, which forms the inner tube 15, towards the outer tube 16, and in an adjacent beam the transverse flange 21 extends from a flange 23, which forms the outer tube 16, towards the inner tube 15. After joining together, the modules 22 will naturally form a single continuous unit.

In FIG. 4b the double wall structure 14 is formed from I-beams, each having a body which forms a stay 21 between the tubes 15, 16, and an upper flange 24 and a lower flange 25, which form a section of the outer tube 16 and a section of the inner tube 15 respectively. Spacers 26, suitably having a rectangular cross-section, are arranged in a circumferential direction between the I-beams in order to extend the flanges 24, 25 and to obtain the required interval between the stays 21.

In FIG. 4c the double wall structure 14 is formed by I-beams 22, or to put it another way horizontal H-beams arranged side by side. Each beam 22 has an upper flange 27, a lower flange 28 and a body 21 arranged between the flanges. The lower flange 28 is suitably somewhat shorter than the upper flange 27, or alternatively wider joints, such as welded joints, are made between the upper flanges 27, which form the outer tube 16, compared to the joints between the lower flanges 28, which form the inner tube 15.

The dimensions of the beams should naturally be adjusted to the size of the casing, and in general terms the tangentially extending parts of the modules 22 which form the inner tube 15 are furthermore suitably shorter than the corresponding parts which form the outer tube 16, since the outer tube 16 has a circumference which is larger than the circumference of the inner tube 15.

The invention also relates to a gas turbine 30, preferably one which forms a jet engine for aviation applications, comprising a compressor 2 and a casing according to the invention, which encloses the compressor. The invention further relates to a gas turbine 30 comprising a casing according to the invention, which is arranged in a position of the gas turbine in which the gas turbine has a waist 10. The invention also relates to a gas turbine 30, which has an outer shell 13 and an inner shell 11 situated between the outer shell and the rotor shaft 5 of the gas turbine, in which gas turbine 30 a casing according to the invention constitutes at least a part of the inner shell 11 and/or a part of the outer shell 13.

It must be emphasized that a plurality of casings according to the invention or casing parts can naturally be arranged in series in an axial direction and joined or coupled together axially in order to form an outer or inner wall structure of a gas turbine. The various casing parts may suitably be provided with flanges and connected by means of bolted connections. It is also possible to combine one or more casing parts according to the invention with one or more conventional casing parts in order to form an inner or outer wall structure of a gas turbine.

The invention can naturally be modified in a number of different ways without departing from the scope of the fundamental idea of the invention, the invention being intended, for example, to also encompass those constructions in which the double wall structure is for any reason not used over the entire circumference of the casing but only in a section or several separate sections of the circumference of the casing.

1. A gas turbine casing for enclosing at least one gas turbine component, the gas turbine casing comprising:
a double wall structure having a first inner tube and a second outer tube, the first inner tube and the second outer tube extending around a geometric longitudinal axis, the geometric longitudinal axis basically coinciding with a longitudinal geometric central axis of a gas turbine, and the first inner tube and the second outer tube overlapping one another when viewed in a radial direction, a gap being formed between an outer boundary surface of the first inner tube and an inner boundary surface of the second outer tube, the double wall structure having a plurality of stays in a form of plates, the stays being spaced at an interval from one another and extending radially between the first inner tube and the second outer tube, the stays connecting the first inner tube and the second outer tube to one another.

2. The casing as claimed in claim 1, wherein the first inner tube has a circular cross-section.

3. The casing as claimed in claim 1, wherein the second outer tube has a circular cross-section.

4. The casing as claimed in claim 1, wherein the first inner tube and the second outer tube are arranged concentrically with one another.

5. The casing as claimed in claim 1, wherein the stays are arranged at intervals from one another in a circumferential direction along the double wall structure.

6. The casing as claimed in claim 5, wherein one or more of the stays basically extends over an entire length of the double wall structure.

7. The casing as claimed in claim 1, wherein the stays are arranged at intervals from one another over a longitudinal extent of the double wall structure.

8. The casing as claimed in claim 7, wherein one or more of the stays basically extends over an entire extent of the double wall structure in a circumferential direction.

9. The casing as claimed in claim 1, wherein the double wall structure is constructed from a plurality of joined modules arranged side by side in the circumferential direction of the casing.

10. The casing as claimed in claim 9, wherein the modules each have at least one stay, and one part forming at least one of a section of the first inner tube and a section of the second outer tube.

11. The casing as claimed in claim 9, wherein the modules are at least one of I-beams, H-beams, and T-beams.

12. The casing as claimed in claim 9, wherein the modules are manufactured by extrusion.

13. The casing as claimed in claim 9, wherein the modules are joined together by welding.

14. A gas turbine comprising a casing as claimed in claim 1.

15. A gas turbine comprising a compressor and a casing as claimed in claim 1 which encloses the compressor.

16. A gas turbine comprising a casing as claimed in claim 1, the casing being arranged in a position of the gas turbine in which the gas turbine has a waist.

17. A gas turbine which has an outer shell and an inner shell arranged between the outer shell and the rotor shaft of the gas turbine, a casing as claimed in claim 1 forming at least a part of at least one of the inner shell and the outer shell.

18. A method of forming a gas turbine casing according to claim 1 for enclosing a gas turbine component, comprising joining a plurality of modules together side by side in a circumferential direction of the casing so that a double wall structure is formed.

19. Use of a gas turbine casing according to claim 1 for enclosing a gas turbine component.
